(19) United States
(12) Patent Application Publication
(10) Pub. No.: US 2026/0092238 A1
(43) Pub. Date: Apr. 2, 2026

(54) COMPOSITION COMPRISING SPORES AND CATIONIC GLUCAN

(71) Applicant: The Procter & Gamble Company, Cincinnati, OH (US)

(72) Inventors: Neil Joseph LANT, Newcastle upon Tyne (GB); Katherine Esther LATIMER, Newcastle upon Tyne (GB); Samuel Kimani NJOROGE, Montgomery, OH (US)

(21) Appl. No.: 19/195,857

(22) Filed: May 1, 2025

(30) Foreign Application Priority Data
May 2, 2024 (EP) 24173890.5

(51) Int. Cl. C11D 3/38; C11D 3/386; C11D 7/26; C11D 17/06

(52) U.S. Cl. CPC C11D 3/381; C11D 3/38645; C11D 7/268; C11D 17/06

(57) ABSTRACT

A surface treatment composition that includes from about 1×10² to about 1×10⁹ CFU/g of the composition of Bacillus spores and from about 0.01% to about 5% by weight of the composition of a cationic polyglucan.

### FIELD OF THE INVENTION

The present invention is in the field of treatment compositions. In particular, it is directed to a treatment composition comprising bacterial spores and a cationic polyglucan. It is also related to a method of treating a surface with the composition. The composition and method of the invention can provide stain removal, second time cleaning benefits and reduction and/or prevention of malodor on the treated surface.

### BACKGROUND OF THE INVENTION

Spores as part of surface treatment compositions can provide stain removal, second time cleaning benefits and malodour prevention and/or removal. Sometimes, deposition of spores on the treated surface can be difficult. This can be more challenging in the case of treatments comprising the step or immersing the surface in water and even more challenging if the treatment comprises a rinsing step, as the case is in a laundry process because water tend to take the spores with it diminishing the amount of spores deposited on the surface.

There is a need for a surface treatment composition that contains spores and presents a good deposition profile, in particular when the treatment involves total immersion of the surface in water and/or rinsing.

### SUMMARY OF THE INVENTION

According to a first aspect of the invention, there is provided a surface treatment composition, for application in laundry, dish and hard surface cleaning, comprising bacterial spores Bacillus spores, and a cationic polyglucan. Preferably, the bacterial spores comprise Bacillus spores.

The surface treatment composition of the invention comprises:
a) from about 1×10² to about 1×10⁹ CFU/g, preferably from 1×10³ to about 1×10⁷ CFU/g and more preferably from 1×10⁴ to about 1×10⁷ CFU/g of the composition of bacterial spores, preferably Bacillus spores; and
b) from about 0.01% to about 10%, preferably from about 0.01% to about 5%, more preferably from about 0.05% to about 3% by weight of the composition of a cationic polyglucan.

According to a second aspect of the invention, there is provided a method of treating a surface, the method comprises the step of treating the surface with the composition of the invention. Preferably, the surface is a fabric or a hard surface. Preferably the method is a cleaning process, preferably the cleaning process involve immersing the surface water and/or a rinsing step. Preferably, the method is a laundry process.

The composition and method of the invention provides improved deposition of spores on surfaces, preferably on fabrics or hard surfaces.

Lastly, there is provided the use of the composition of the invention to provide improved spore deposition on a treated surface.

The elements of the composition of the invention described in relation to the first aspect of the invention apply mutatis mutandis to the other aspects of the invention.

### DETAILED DESCRIPTION OF THE INVENTION

The present invention encompasses a composition, for application in laundry, dish and hard surface cleaning, comprising bacterial spores, preferably Bacillus spores and a cationic polyglucan. The present invention also encompasses a method of treating a surface using the composition of the invention. The present invention also encompasses the use of the method and the composition of the invention to provide improved deposition of spores on a surface, preferably a fabric or a hard surface, more preferably a fabric. The cationic polyglucan could act as prebiotic one the spores have germinated.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Composition

The present disclosure relates to a composition for treating a surface. The composition is suitable for use on hard surfaces and soft surfaces. Preferably the composition of the invention comprises a surfactant system. The composition may be a cleaning composition. It may be hard surface cleaning or laundry cleaning composition. In the case of hard surface cleaning, it is preferably an aqueous composition, it may be acid or alkaline and it may be in concentrated form or in the form of ready-to-use composition. Alternatively, the hard surface cleaning composition can be in the form of a bead. In the case of hard surface cleaning beads, the composition may comprise a plurality of particles, said particles comprise:
1. from 20% to 70% of polyalkylene glycol having a weight average molecular weight from 2000 to 40000 by total weight of said particles;
2. from 10% to 70% of an effervescent system by total weight of said particles; and
3. from 0.1% to 50% of perfume by total weight of said particles.

The composition may be a laundry additive, such as a bead or a drying sheet. The composition may be a fabric enhancer composition.

By “hard surface cleaning composition”, it is meant herein a based liquid composition for cleaning hard surfaces found in households, especially domestic households. Surfaces to be cleaned include kitchens and bathrooms, e.g., floors, walls, tiles, windows, cupboards, sinks, showers, plastified shower curtains, wash basins, WCs, fixtures and fittings and the like made of different materials like ceramic, vinyl, no-wax vinyl, linoleum, melamine, glass, steel, kitchen work surfaces, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments. Preferably, the hard surface cleaning composition is an aqueous composition.

Soft surfaces treating compositions may include but are not limited to, laundry cleaning compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the wash and/or rinse cycle of the laundering process.

The composition may be in any suitable form. It may be in the form of a liquid composition, a granular composition, a single-compartment pouch, a multi-compartment pouch, a sheet, a pastille or bead, a fibrous article, a tablet, a bar, flake, or a mixture thereof. The product can be selected from a liquid, solid, or combination thereof.

The composition may be in liquid form. The composition may include from about 30% to about 90%, or from about 50% to about 80%, by weight of the composition, of water. The pH of the composition may be optimized to facilitate bacterial spores stability.

The composition may be a cleaning or additive composition, it may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The composition may be in the form of a pastille or bead. The pastille may include polyethylene glycol as a carrier. The polyethylene glycol may have a weight average molecular weight of from about 2000 to about 20,000 Daltons, preferably from about 5000 to about 15,000 Daltons, more preferably from about 6,000 to about 12,000 Daltons.

The composition may comprise a non-aqueous solvent, which may act as a carrier and/or facilitate stability. Non-aqueous solvents may include organic solvents, such as methanol, ethanol, propanol, isopropanol, 1,3-propanediol, 1,2-propanediol, ethylene glycol, glycerine, glycol ethers, hydrocarbons, or mixtures thereof. Other non-aqueous solvents may include lipophilic fluids such as siloxanes or other silicones, hydrocarbons, perfluorinated amines, perfluorinated and hydrofluoroether solvents, or mixtures thereof. Amine-containing solvents, such as monoethanolamine, diethanolamine and triethanolamine, may be suitable.

Especially preferred compositions herein are laundry compositions.

### Bacterial Spores

The composition of the invention comprises from about 1×10² to about 1×10⁹ CFU/g, preferably from 1×10³ to about 1×10⁷ CFU/g and more preferably from 1×10⁴ to about 1×10⁷ CFU/g of the composition of bacterial spores, preferably Bacillus spores. Although bacterial spores can be present on surfaces, the method of the invention involves the intentional addition of bacterial spores to the surface in an amount capable of providing a consumer noticeable benefit, in particular sustained perfume release. Preferably, the method of the invention requires the intentional addition of at least 1×10² CFU/g of surface and preferably less than 1×10⁷ CFU/g of surface. Preferably if the surface is a fabric and the fabric is treated in a laundry process then the level of bacterial spores is from about 1×10² to 1×10⁴ CFU/g of surface. And for methods involving direct applications, such as sprays, the level of bacterial spores would be from about 1×10⁴ to 1×10⁶ CFU/g of surface. By “intentional addition of bacterial spores” is herein meant that the spores are added in addition to the microorganisms that might be present on the surface.

The composition of the invention can be in the form of a fabric treatment composition and it may be added to a wash, rinse or drying cycle, preferably the composition is added into a wash or rinse cycle. The spores are not deactivated by heat at the temperatures found in a washing machine or in a dryer. The spores are fabric-substantive and provide fragrance release benefit.

The bacterial spores of the method and composition of the invention can germinate on surfaces. The spores can be activated by heat, for example, heat generated during use of the fabric or by the heat provided in the washing machine. The spores can germinate when the fabrics are stored and/or used.

The fabric can be treated in a wet laundry process, or it can be treated wet after being washed, for example in the dryer or being sprayed. Alternatively, the fabric can be treated with a composition in the form of a spray in order to refresh it.

Preferably, the bacterial spores for use herein: i) are capable of surviving the temperatures found in a laundry process; ii) are fabric substantive; and iii) have the ability to excrete enzymes and release the perfume from the pro-perfume material. The spores have the ability to germinate and to form cells during the use of the surface. The spores can be delivered in liquid or solid form. Preferably, the spores are in solid form.

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Bacterial spores may be differentiated from vegetative cells using a variety of techniques, like phase-contrast microscopy, automated scanning microscopy, high resolution atomic force microscopy or tolerance to heat, for example.

Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment to germinate into vegetative cells and perform an intended function. A variety of different bacteria may form spores. Bacteria from any of these groups may be used in the compositions, methods, and kits disclosed herein. For example, some bacteria of the following genera may form spores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/or Vulcanobacillus.

Preferably, the bacteria that may form spores are from the family Bacillaceae, such as species of the genera Aeribacillus, Aliibacillus, Alkalibacillus, Alkalicoccus, Alkalihalobacillus, Alkalilactibacillus, Allobacillus, Alteribacillus, Alteribacter, Amphibacillus, Anaerobacillus, Anoxybacillus, Aquibacillus, Aquisalibacillus, Aureibacillus, Bacillus, Caldalkalibacillus, Caldibacillus, Calditerricola, Calidifontibacillus, Camelliibacillus, Cerasibacillus, Compostibacillus, Cytobacillus, Desertibacillus, Domibacillus, Ectobacillus, Evansella, Falsibacillus, Ferdinandcohnia, Fermentibacillus, Fictibacillus, Filobacillus, Geobacillus, Geomicrobium, Gottfriedia, Gracilibacillus, Halalkalibacillus, Halobacillus, Halolactibacillus, Heyndrickxia, Hydrogenibacillus, Lederbergia, Lentibacillus, Litchfieldia, Lottiidibacillus, Margalitia, Marinococcus, Melghiribacillus, Mesobacillus, Metabacillus, Microaerobacter, Natribacillus, Natronobacillus, Neobacillus, Niallia, Oceanobacillus, Ornithinibacillus, Parageobacillus, Paraliobacillus, Paralkalibacillus, Paucisalibacillus, Pelagirhabdus, Peribacillus, Piscibacillus, Polygonibacillus, Pontibacillus, Pradoshia, Priestia, Pseudogracilibacillus, Pueribacillus, Radiobacillus, Robertmurraya, Rossellomorea, Saccharococcus, Salibacterium, Salimicrobium, Salinibacillus, Salipaludibacillus, Salirhabdus, Salisediminibacterium, Saliterribacillus, Salsuginibacillus, Sediminibacillus, Siminovitchia, Sinibacillus, Sinobaca, Streptohalobacillus, Sutcliffiella, Swionibacillus, Tenuibacillus, Tepidibacillus, Terribacillus, Terrilactibacillus, Texcoconibacillus, Thalassobacillus, Thalassorhabdus, Thermolongibacillus, Virgibacillus, Viridibacillu, Vulcanibacillus, Weizmannia. In various examples, the bacteria may be strains of Bacillus Bacillus acidicola, Bacillus aeolius, Bacillus aerius, Bacillus aerophilus, Bacillus albus, Bacillus altitudinis, Bacillus alveayuensis, Bacillus amyloliquefaciensex, Bacillus anthracis, Bacillus aquiflavi, Bacillus atrophaeus, Bacillus australimaris, Bacillus badius, Bacillus benzoevorans, Bacillus cabrialesii, Bacillus canaveralius, Bacillus capparidis, Bacillus carboniphilus, Bacillus cereus, Bacillus chungangensis, Bacillus coahuilensis, Bacillus cytotoxicus, Bacillus decisifrondis, Bacillus ectoiniformans, Bacillus enclensis, Bacillus fengqiuensis, Bacillus fungorum, Bacillus glycinifermentans, Bacillus gobiensis, Bacillus halotolerans, Bacillus haynesii, Bacillus horti, Bacillus inaquosorum, Bacillus infantis, Bacillus infernus, Bacillus isabeliae, Bacillus kexueae, Bacillus licheniformis, Bacillus luti, Bacillus manusensis, Bacillus marinisedimentorum, Bacillus mesophilus, Bacillus methanolicus, Bacillus mobilis, Bacillus mojavensis, Bacillus mycoides, Bacillus nakamurai, Bacillus ndiopicus, Bacillus nitratireducens, Bacillus oleivorans, Bacillus pacificus, Bacillus pakistanensis, Bacillus paralicheniformis, Bacillus paramycoides, Bacillus paranthracis, Bacillus pervagus, Bacillus piscicola, Bacillus proteolyticus, Bacillus pseudomycoides, Bacillus pumilus, Bacillus safensis, Bacillus salacetis, Bacillus salinus, Bacillus salitolerans, Bacillus seohaeanensis, Bacillus shivajii, Bacillus siamensis, Bacillus smithii, Bacillus solimangrovi, Bacillus songklensis, Bacillus sonorensis, Bacillus spizizenii, Bacillus spongiae, Bacillus stercoris, Bacillus stratosphericus, Bacillus subtilis, Bacillus swezeyi, Bacillus taeanensis, Bacillus tamaricis, Bacillus tequilensis, Bacillus thermocloacae, Bacillus thermotolerans, Bacillus thuringiensis, Bacillus tianshenii, Bacillus toyonensis, Bacillus tropicus, Bacillus vallismortis, Bacillus velezensis, Bacillus wiedmannii, Bacillus wudalianchiensis, Bacillus xiamenensis, Bacillus xiapuensis, Bacillus zhangzhouensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumilus strain NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilisstrain NRRL B-50147 (also known as 300R); Bacillus amyloliquefaciens strain NRRL B-50150; Bacillus amyloliquefaciens strain NRRL B-50154; Bacillus megaterium PTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciens FZB24 (e.g., isolates NRRL B-50304 and NRRL B-50349 TAEGRO® from Novozymes), Bacillus pumilus (e.g., isolate NRRL B-50349 from Bayer CropScience), Bacillus amyloliquefaciens TrigoCor (also known as “TrigoCor 1448”; e.g., isolate Embrapa Trigo Accession No. 144/88.4Lev, Cornell Accession No. Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

In some examples, the bacterial strains that form spores may be Brevibacillus spp., e.g., Brevibacillus brevis; Brevibacillus formosus; Brevibacillus laterosporus; or Brevibacillus parabrevis, or combinations thereof.

In some examples, the bacterial strains that form spores may be Paenibacillus spp., e.g., Paenibacillus alvei; Paenibacillus amylolyticus; Paenibacillus azotofixans; Paenibacillus cookii; Paenibacillus macerans; Paenibacillus polymyxa; Paenibacillus validus, or combinations thereof.

The bacterial spores may have an average particle diameter of about 2-50 microns, suitably about 10-45 microns. Bacillus spores are commercially available in blends in aqueous carriers and are insoluble in the aqueous carriers. Other commercially available bacillus spore blends include without limitation Freshen Free™ CAN (10×), available from Novozymes Biologicals, Inc.; Evogen® Renew Plus (10×), available from Genesis Biosciences, Inc.; and Evogen® GT (10×, 20×and 110×), all available from Genesis Biosciences, Inc. In the foregoing list, the parenthetical notations (10×, 20×, and 110×) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated. Preferably, the spores used herein are heat activated. Heat activation may comprise heating bacterial spores from room temperature (15-25° C.) to optimal temperature of between 25-120° C., preferably between 40 C-100° C., and held the optimal temperature for not more than 2 hours, preferably between 70-80° C. for 30 min.

For the methods and compositions disclosed herein, populations of bacterial spores are generally used. In some examples, a population of bacterial spores may include bacterial spores from a single strain of bacterium. Preferably, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/(spores in population+vegetative cells in population))×100). Generally, populations of bacterial spores used in the disclosed methods, compositions and products are stable (i.e. not undergoing germination), with at least some individual spores in the population capable of germinating.

### Cationic Polyglucans

A glucan is a polysaccharide derived from D-glucose, linked by glycosidic bonds. Glucans can be presented in two forms: alpha glucans and beta glucans. The cationic polyglucan is preferably selected from the group consisting of a poly alpha-1,6-glucan ether compound, a poly alpha-1,3-glucan ether compound and a mixture thereof.

The composition of the invention preferably comprises from about 0.01% to about 10%, preferably from about 0.05% to about 5% by weight of the composition of cationic polyglucans.

### Poly Alpha-1,6-Glucan Ether Compound

The treatment compositions of the present disclosure can comprise a poly alpha-1,6-glucan ether compound that is cationically substituted.

More specifically, the poly alpha-1,6-glucan ether compound comprises a poly alpha-1,6-glucan substituted with at least one positively charged organic group, where the poly alpha-1,6-glucan comprises a backbone of glucose monomer units, where at least 65% of the glucose monomer units are linked via alpha-1,6-glycosidic linkages. The poly alpha-1,6-glucan ether compound may be characterized by (a) a weight average degree of polymerization of at least 5; (b) a weight average molecular weight of from about 1000 to about 500,000 daltons; and/or (c) having been derived from a poly alpha-1,6-glucan having a weight average molecular weight of from about 900 to about 450,000 daltons, determined prior to substitution with the least one positively charged organic group. The poly alpha-1,6-glucan ether compound may be characterized by a degree of substitution of about 0.001 to about 3.0. Optionally, at least 5%, preferably from about 5% to about 50%, more preferably from about 5% to about 35%, of the backbone glucose monomer units have branches via alpha-1,2 and/or alpha-1,3-glycosidic linkages. These compounds, groups, and properties are described in more detail below.

The poly alpha-1,6-glucan ether compounds disclosed herein comprise poly alpha-1,6-glucan substituted with at least one positively charged organic group, wherein the organic group or groups are independently linked to the poly alpha-1,6-glucan polysaccharide backbone and/or to any branches, if present, through an ether (—O—) linkage. The at least one positively charged organic group can derivatize the poly alpha-1,6-glucan at the 2, 3, and/or 4 glucose carbon position(s) of a glucose monomer on the backbone of the glucan, and/or at the 1, 2, 3, 4, or 6 glucose carbon position(s) of a glucose monomer on a branch, if present. At unsubstituted positions a hydroxyl group is present in a glucose monomer.

The poly alpha-1,6-glucan ether compounds disclosed herein are referred to as “cationic” ether compounds due to the presence of one or more positively charged organic groups. The terms “positively charged organic group”, “positively charged ionic group”, and “cationic group” are used interchangeably herein. A positively charged group comprises a cation (a positively charged ion). Examples of positively charged groups include substituted ammonium groups, carbocation groups, and acyl cation groups.

The cationic poly alpha-1,6-glucan ether compounds disclosed herein comprise water-soluble poly alpha-1,6-glucan comprising a backbone of glucose monomer units wherein at least 65% of the glucose monomer units are linked via alpha-1,6-glycosidic linkages, and optionally at least 5% of the backbone glucose monomer units have branches via alpha-1,2 and/or alpha-1,3-glycosidic linkages. The poly alpha-1,6-glucan is substituted with positively charged organic groups on the polysaccharide backbone and/or on any branches which may be present, such that the poly alpha-1,6-glucan ether compound comprises unsubstituted and substituted alpha-D-glucose rings. The poly alpha-1,6-glucan may be randomly substituted with positively charged organic groups. As used herein, the term “randomly substituted” means the substituents on the glucose rings in the randomly substituted polysaccharide occur in a non-repeating or random fashion. That is, the substitution on a substituted glucose ring may be the same or different (i.e. the substituents, which may be the same or different, on different atoms in the glucose rings in the polysaccharide) from the substitution on a second substituted glucose ring in the polysaccharide, such that the overall substitution on the polymer has no pattern. Further, the substituted glucose rings may occur randomly within the polysaccharide (i.e., there is no pattern with the substituted and unsubstituted glucose rings within the polysaccharide).

Depending on reaction conditions and the specific substituent used to derivatize the poly alpha-1,6-glucan, the glucose monomers of the polymer backbone may be disproportionately substituted relative to the glucose monomers of any branches, including branches via alpha-1,2 and/or alpha-1,3 linkages, if present. The glucose monomers of the branches, including branches via alpha-1,2 and/or alpha-1,3 linkages, if present, may be disproportionately substituted relative to the glucose monomers of the polymer backbone. Depending on reaction conditions and the specific substituent used, substitution of the poly alpha-1,6-glucan may occur in a block manner.

Depending on reaction conditions and the specific substituent used to derivatize the poly alpha-1,6-glucan, it is possible that the hydroxyl groups at certain glucose carbon positions may be disproportionately substituted. For example, the hydroxyl at carbon position 6 for a branched unit may be more substituted than the hydroxyls at other carbon positions. The hydroxyl at carbon position 2, 3, or 4 may be more substituted than the hydroxyls at other carbon positions. The poly alpha-1,6-glucan ether compounds disclosed herein contain positively charged organic groups and are of interest due to their solubility characteristics in water, which can be varied by appropriate selection of substituents and the degree of substitution.

### Poly Alpha-1,3-Glucan Ether Compound

The poly alpha-1,3-glucan ether compound may comprise from about 425 to about 1200 structural units having the following structure:

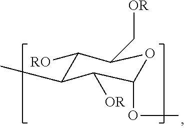

where each R is independently an H or a positively charged organic group. The poly alpha-1,3-glucan ether compound may comprise from about 500 to about 1100, or from about 600 to about 1050, or from about 700 to about 1000, or from about 700 to about 900, or from about 700 to about 800, repeats of the indicated structural unit. As indicated below, proper selection of the number of structural units (and thus, molecular weight) is desired to provide an effective conditioning composition. Each R is independently an H or a positively charged organic group, wherein the positively charged organic group may comprise a substituted ammonium group, preferably a quaternary ammonium group, more preferably a trialkyl ammonium group, even more preferably a trimethylammonium group. The poly alpha-1,3-glucan ether compound may comprise other structural units, including structural units that serve as branch points, although little-to-no branching is preferred.

The poly alpha-1,3-glucan ether compound may be represented by the structure:

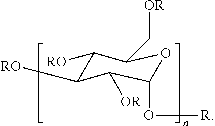

Regarding the formula of this structure, n can be from about 425 to about 1200, and each R in the compound may independently be an H or a positively charged organic group. Furthermore, the poly alpha-1,3-glucan ether compound may have a degree of substitution of about 0.15 to about 0.8.

The degree of substitution (DoS) of a poly alpha-1,3-glucan ether compound disclosed herein may be from about 0.15 to about 0.8, or from about 0.3 to about 0.7, or from about 0.3 to about 0.6, or from about 0.4 to about 0.6, or from about 0.4 to about 0.5. When the glucan ether compound is intended to be used in a through-the-wash application (e.g., as part of or in combination with a laundry detergent), the DoS may be from about 0.15 to about 0.6. When the glucan ether compound is intended to be used in a through-the-rinse application (e.g., as part of a liquid fabric enhancer), the DoS may be from about 0.3 to about 0.8. It would be understood by those skilled in the art that since a poly alpha-1,3-glucan ether compound herein has a degree of substitution between about 0.15 to about 0.8, and by virtue of being an ether, the R groups of the compound cannot only be hydrogen.

The percentage of glycosidic linkages between the glucose monomer units of poly alpha-1,3-glucan ether compounds herein that are alpha-1,3 is at least about 50%, 60%, 70%, 80%, 90%, 95%, 96%, 97%, 98%, 99%, or 100% (or any integer between 50% and 100%). In such embodiments, accordingly, the compound has less than about 50%, 40%, 30%, 20%, 10%, 5%, 4%, 3%, 2%, 1%, or 0% (or any integer value between 0% and 50%) of glycosidic linkages that are not alpha-1,3.

The backbone of a poly alpha-1,3-glucan ether compound herein is preferably substantially linear/unbranched. For example, the compound may have no branch points or fewer than about 10%, 9%, 8%, 7%, 6%, 5%, 4%, 3%, 2%, or 1% branch points as a percent of the glycosidic linkages in the polymer. Examples of branch points include alpha-1,6 branch points. It is believed that having relatively few branch points results in a relatively more-water-soluble polymer, which can facilitate case of formulation.

For poly alpha-1,3-glucan ether compounds described above, the index n may be from about 425 to about 1200, or from about 500 to about 1100, or from about 600 to about 1050, or from about 600 to about 1000, or from about 700 to about 1000, or from about 700 to about 900, or from about 700 to about 800. It is believed that proper selection of the size of the molecule (which impacts the weight average molecular weight) is important to facilitate improved conditioning active performance and the conditioning compounds that contain them. For example, if the size of the molecule is too small, conditioning actives may not be adequately deposited; if the size of the molecule is too large, viscosity of the composition may be negatively impacted, for example by becoming too viscous.

The molecular weight of a poly alpha-1,3-glucan ether compound herein can be measured as weight-average molecular weight (M_{w}). Weight average molecular weight is determined by size exclusion chromatography (SEC), as described in more detail in the Test Methods section. The poly alpha-1,3-glucan ether compound herein may be characterized by a weight average molecular weight (M_{w}) of from about 90 kDaltons to about 350 kDaltons, or from about 90 to about 300 kDaltons, or from about 90 kDaltons to about 260 kDaltons, or from about 90 to about 240 kDaltons, or from about 95 to about 200 kDaltons, or from about 100 to about 175 kDaltons, or from about 100 to about 150 kDaltons, which is most preferred.

The poly alpha-1,3-glucan ether compound herein may be derived from a polysaccharide backbone characterized by a weight average molecular weight of from about 90 kDaltons to about 190 kDaltons, as determined prior to substitution. For a linear polymer of about 120 kdaltons, the number of repeat units is 740. This poly dispersity can range between 1 to about 5 and more preferably 1 to about 3.

Each R group in the formula of a poly alpha-1,3-glucan ether compound herein can independently be an H or a positively charged organic group. As defined above, a positively charged organic group comprises a chain of one or more carbons having one or more hydrogens substituted with another atom or functional group, where one or more of the substitutions is with a positively charged group.

A positively charged group may be a substituted ammonium group, for example. Examples of substituted ammonium groups are primary, secondary, tertiary and quaternary ammonium groups. Structure I, as described above, depicts a primary, secondary, tertiary or quaternary ammonium group, depending on the composition of R₂, R₃ and R₄ in structure I. Each of R₂, R₃ and R₄ in structure I independently represent a hydrogen atom or an alkyl, aryl, cycloalkyl, aralkyl, or alkaryl group. Alternatively, each of R₂, R₃ and R₄ in can independently represent a hydrogen atom or an alkyl group. An alkyl group herein can be a methyl, ethyl, propyl, butyl, pentyl, hexyl, heptyl, octyl, nonyl, or decyl group, for example. Where two or three of R₂, R₃ and R₄ are an alkyl group, they can be the same or different alkyl groups.

Quaternary ammonium poly alpha-1,3-glucan ether compounds are preferred. A “quaternary ammonium poly alpha-1,3-glucan ether compound” herein can comprise a positively charged organic group having a trialkylammonium group, for example. In this example, the positively charged organic group comprises structure I in which each of R₂, R₃ and R₄ is an alkyl group. A non-limiting example of such a positively charged organic group is represented by structure II when each of R₂, R₃ and R₄ is an alkyl group. An example of a quaternary ammonium poly alpha-1,3-glucan ether compound can be represented in shorthand as trialkylammonium poly alpha-1,3-glucan ether (e.g., trimethyl-, triethyl-, tripropyl-, tributyl-, tripentyl-, trihexyl-, triheptyl-, trioctyl-, trinonyl- or tridecyl-ammonium poly alpha-1,3-glucan ether). It would be understood that a fourth member (i.e., R₁) implied by “quaternary” in the above nomenclature is the chain of one or more carbons of the positively charged organic group that is ether-linked to a glucose monomer of poly alpha-1,3-glucan.

Although quaternary compounds are preferred, the compositions of the present disclosure may include primary, secondary, and/or tertiary ammonium poly alpha-1,3-glucan ether compounds, for example as impurities and/or partially reacted reaction products.

Additional non-limiting examples of substituted ammonium groups that can serve as a positively charged group herein are represented in structure I when each of R₂, R₃ and R₄ independently represent a hydrogen atom; an alkyl group such as a methyl, ethyl, or propyl group; an aryl group such as a phenyl or naphthyl group; an aralkyl group such as a benzyl group; an alkaryl group; or a cycloalkyl group. Each of R₂, R₃ and R₄ may further comprise an amino group or a hydroxyl group, for example.

The nitrogen atom in a substituted ammonium group represented by structure I is bonded to a chain of one or more carbons as comprised in a positively charged organic group. This chain of one or more carbons (“carbon chain”) is ether-linked to a glucose monomer of poly alpha-1,3-glucan, and may have one or more substitutions in addition to the substitution with the nitrogen atom of the substituted ammonium group. There can be 1, 2, 3, 4, 5, 6, 7, 8, 9, 10, 11, 12, 13, or 14 carbons, for example, in a carbon chain herein. To illustrate, the carbon chain of structure II is 3 carbon atoms in length.

Where a carbon chain of a positively charged organic group has a substitution in addition to a substitution with a positively charged group, such additional substitution may be with one or more hydroxyl groups, oxygen atoms (thereby forming an aldehyde or ketone group), alkyl groups (e.g., methyl, ethyl, propyl, butyl), and/or additional positively charged groups. A positively charged group is typically bonded to the terminal carbon atom of the carbon chain. The carbon chain may include one or more substitutions that include a hydroxyl group, preferably a hydroxyalkyl group, more preferably a hydroxypropyl group.

Poly alpha-1,3-glucan ether compounds in certain embodiments disclosed herein may contain one type of positively charged organic group as an R group. For example, one or more positively charged organic groups ether-linked to the glucose monomer of poly alpha-1,3-glucan may be trimethylammonium hydroxypropyl groups (structure II); the R groups in this particular example would thus independently be hydrogen and trimethylammonium hydroxypropyl groups.

Alternatively, poly alpha-1,3-glucan ether compounds disclosed herein can contain two or more different types of positively charged organic groups as R groups.

Poly alpha-1,3-glucan ether compounds herein can comprise at least one nonionic organic group and at least one anionic group, for example. As another example, poly alpha-1,3-glucan ether compounds herein can comprise at least one nonionic organic group and at least one positively charged organic group.

Poly alpha-1,3 glucan and/or poly alpha-1,3-glucan ethers herein are mostly or completely stable (resistant) to being degraded by cellulase enzymes. For example, the percent degradation of a poly alpha-1,3 glucan and/or poly alpha-1,3-glucan ether compound by one or more cellulases is less than 10%, 9%, 8%, 7%, 6%, 5%, 4%, 3%, 2%, or 1%, or is 0%. Such percent degradation can be determined, for example, by comparing the molecular weight of polymer before and after treatment with a cellulase for a period of time (e.g., ˜24 hours). Advantageously, such compounds may be co-formulated with cellulase, used concurrently with cellulase-containing products, or sequentially with such products where residual cellulase may remain on a surface and/or in an aqueous environment.

The poly alpha-1,3-glucan ether disclosed herein comprise a backbone of poly alpha-1,3-glucan randomly substituted with ether modifications along the polysaccharide backbone, such that the polysaccharide backbone comprises unsubstituted and substituted alpha-D-glucose rings. In embodiments wherein branches exist, the alpha-D-glucose rings of the branches may also be randomly substituted with ether modification groups. As used herein, the term “randomly substituted” means the substituents on the glucose rings in the randomly substituted polysaccharide occur in a non-repeating or random fashion. That is, the substitution on a substituted glucose ring may be the same or different [i.e. the substituents (which may be the same or different) on different atoms in the glucose rings in the polysaccharide] from the substitution on a second substituted glucose ring in the polysaccharide, such that the overall substitution on the polymer has no pattern. Further, the substituted glucose rings occur randomly within the polysaccharide (i.e., there is no pattern with the substituted and unsubstituted glucose rings within the polysaccharide).

Depend on the reaction conditions, it is also possible that the poly alpha-1,3-glucan ether compound disclosed herein comprise a backbone of poly alpha-1,3-glucan “non-randomly” substituted with ether modification groups along the polysaccharide backbone. In the situation where branches exist, it is possible the alpha-D-glucose rings of the branches could disproportionally contain more substitution than the backbone glucose monomer units which linked via alpha-1,3-glycosidic linkages. It is also possible that in certain reaction conditions the modification may exist in a block manner within the polysaccharide.

Depending on the reaction conditions, it is also possible that glucose carbon positions 1, 2, 3, 4, and 6 of the poly alpha-1,3-glucan backbone are “disproportionally” substituted. For example, the —OH group at carbon position 6 is a primary hydroxyl group and may exist in an environment which have less steric hindrance; therefore, this —OH group may have higher reactivity in certain reaction conditions, and thus, more substitution may happen at this position. In other reaction conditions, it may be possible that the —OH group at carbon position 1, 2, 3, or 4 have higher reactivity.

Suitable cleaning ingredients include at least one of a surfactant system, an enzyme, an enzyme stabilizing system, a detergent builder, a chelating agent, a complexing agent, clay soil removal/anti-redeposition agents, polymeric soil release agents, polymeric dispersing agents, polymeric grease cleaning agents, a dye transfer inhibiting agent, a bleaching agent, a bleach activator, a bleaching catalyst, a fabric conditioner, a clay, a foam booster, an anti-foam, a suds suppressor, an anti-corrosion agent, a soil-suspending agent, a dye, a hueing dye, a bactericide, a tarnish inhibitor, an optical brightener, a perfume, a saturated or unsaturated fatty acid, a calcium cation, a magnesium cation, a visual signaling ingredient, a structurant, a thickener, an anti-caking agent, a starch, sand, a gelling agents, or any combination thereof.

Surfactant System: The composition may comprise a surfactant system in an amount sufficient to provide desired cleaning properties. In some embodiments, the composition comprises, by weight of the composition, from about 0.1% to about 70% of a surfactant system, preferably from about 0.5% to about 60% of the surfactant system. Preferably, the composition comprises, by weight of the composition, from about 1% to about 30% of the surfactant system. In the case of a ready-to-use hard cleaning surface composition, the composition may comprise from 0.01% to 5%, preferably from 0.1% to 4% by weight of the composition of surfactant system. The surfactant system may comprise a detersive surfactant selected from anionic surfactants, nonionic surfactants, cationic surfactants, zwitterionic surfactants, amphoteric surfactants, ampholytic surfactants, and mixtures thereof. Those of ordinary skill in the art will understand that a detersive surfactant encompasses any surfactant or mixture of surfactants that provide cleaning, stain removing, or laundering benefit to soiled material. Preferably, the surfactant system when present in the composition of the invention comprises and anionic surfactant and a non-ionic surfactant.

Anionic Surfactant. Non-limiting examples of suitable anionic surfactants include any conventional anionic surfactant, such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap.

Nonionic surfactant. Suitable nonionic surfactants useful herein can comprise any conventional nonionic surfactant. These can include, for e.g., alkoxylated fatty alcohols and amine oxide surfactants. Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates wherein the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA); C₁₄-C₂₂ mid-chain branched MEA (BAEₓ), wherein x is from 1 to 30; polyhydroxy fatty acid amides; and ether capped poly(oxyalkylated) alcohol surfactants. Suitable nonionic detersive surfactants also include alkyl alkoxylated alcohol. Suitable nonionic surfactants also include those sold under the tradename Lutensol® from BASF.

Cationic Surfactant. The surfactant system may comprise a cationic surfactant. When the composition of the invention is a cleaning composition, the composition is preferably free of cationic surfactant. When the composition is a fabric enhancer, the composition preferably comprises a cationic surfactant. Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, specifically amido propyldimethyl amine (APA).

Zwitterionic Surfactant. Examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. Betaines, including alkyl dimethyl betaine and cocodimethyl amidopropyl betaine, C₈ to C₁₈ (for example from C₁₂ to C₁₈) amine oxides and sulfo and hydroxy betaines, such as N-alkyl-N,N-dimethylamino-1-propane sulfonate where the alkyl group can be C₈ to C₁₈ and in certain embodiments from C₁₀ to C₁₄.

Amphoteric Surfactant. Examples of amphoteric surfactants include aliphatic derivatives of secondary or tertiary amines, or aliphatic derivatives of heterocyclic secondary and tertiary amines in which the aliphatic radical may be straight- or branched-chain and where one of the aliphatic substituents contains at least about 8 carbon atoms, typically from about 8 to about 18 carbon atoms, and at least one of the aliphatic substituents contains an anionic water-solubilizing group, e.g. carboxy, sulfonate, sulfate. Examples of compounds falling within this definition are sodium 3-(dodecylamino) propionate, sodium 3-(dodecylamino) propane-1-sulfonate, sodium 2-(dodecylamino)ethyl sulfate, sodium 2-(dimethylamino) octadecanoate, disodium 3-(N-carboxymethyldodecylamino) propane 1-sulfonate, disodium octadecyl-imminodiacetate, sodium 1-carboxymethyl-2-undecylimidazole, and sodium N,N-bis(2-hydroxyethyl)-2-sulfato-3-dodecoxypropylamine. Suitable amphoteric surfactants also include sarcosinates, glycinates, taurinates, and mixtures thereof.

Enzymes. Preferably the composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. Preferably, when the composition of the invention is a laundry composition, it comprises an amylase, a protease, a cellulase and optionally a lipase. Preferably, the compositions of the invention are free of glucanases.

Proteases. Preferably the composition comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), especially those derived from Bacillus, such as Bacillus sp., B. lentus, B. alkalophilus, B. subtilis, B. amyloliquefaciens, B. pumilus, B. gibsonii, and B. akibaii described in WO2004067737, WO2015091989, WO2015091990, WO2015024739, WO2015143360, U.S. Pat. No. 6,312,936 B1, U.S. Pat. Nos. 5,679,630, 4,760,025, DE102006022216A1, DE102006022224A1, WO2015089447, WO2015089441, WO2016066756, WO2016066757, WO2016069557, WO2016069563, WO2016069569.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.
(d) Protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604), and KAP (Bacillus alkalophilus subtilisin with mutations A230V+S256G+S259N) from Kao.

Amylases. Preferably the composition may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) variants described in WO 94/02597, WO 94/18314, WO96/23874 and WO 97/43424, especially the variants with substitutions in one or more of the following positions versus the enzyme listed as SEQ ID No. 2 in WO 96/23874:15, 23, 105, 106, 124, 128, 133, 154, 156, 181, 188, 190, 197, 202, 208, 209, 243, 264, 304, 305, 391, 408, and 444.
(b) variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:
26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.
(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.
(d) variants exhibiting at least 95% identity with the wild-type enzyme from Bacillus sp. 707 (SEQ ID NO:7 in U.S. Pat. No. 6,093,562), especially those comprising one or more of the following mutations M202, M208, S255, R172, and/or M261. Preferably said amylase comprises one or more of M202L, M202V, M202S, M202T, M202I, M202Q, M202W, S255N and/or R172Q. Particularly preferred are those comprising the M202L or M202T mutations.
(e) variants described in WO 09/149130, preferably those exhibiting at least 90% identity with SEQ ID NO: 1 or SEQ ID NO:2 in WO 09/149130, the wild-type enzyme from Geobacillus stearothermophilus or a truncated version thereof.
(f) variants exhibiting at least 89% identity with SEQ ID NO:1 in WO2016091688, especially those comprising deletions at positions H183+G184 and additionally one or more mutations at positions 405, 421, 422 and/or 428.
(g) variants exhibiting at least 60% amino acid sequence identity with the “PcuAmyl α-amylase” from Paenibacillus curdlanolyticus YK9 (SEQ ID NO:3 in WO2014099523).
(h) variants exhibiting at least 60% amino acid sequence identity with the “CspAmy2 amylase” from Cytophaga sp. (SEQ ID NO:1 in WO2014164777).
(i) variants exhibiting at least 85% identity with AmyE from Bacillus subtilis (SEQ ID NO: 1 in WO2009149271).
(j) Variants exhibiting at least 90% identity variant with the wild-type amylase from Bacillus sp. KSM-K38 with accession number AB051102.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASER, PURASTAR®, ENZYSIZE®, OPTISIZE HT PLUS®, POWERASE® and PURASTAR OXAM® (Genencor International Inc., Palo Alto, California) and KAM® (Kao, 14-10 Nihonbashi Kayabacho, 1-chome, Chuo-ku Tokyo 103-8210, Japan). In one aspect, suitable amylases include NATALASE®, STAINZYME® and STAINZYME PLUS® and mixtures thereof.

The terms “cellulase” and “cellulase enzyme” are used interchangeably herein to refer to an enzyme that hydrolyzes β-1,4-D-glucosidic linkages in cellulose, thereby partially or completely degrading cellulose. Cellulase can alternatively be referred to as “β-1,4-glucanase”, for example, and can have endocellulase activity (EC 3.2.1.4), exocellulase activity (EC 3.2.1.91), or cellobiase activity (EC 3.2.1.21). A cellulase in certain embodiments herein can also hydrolyze β-1,4-D-glucosidic linkages in cellulose ether derivatives such as carboxymethyl cellulose. “Cellulose” refers to an insoluble polysaccharide having a linear chain of β-1,4-linked D-glucose monomeric units.

Lipases. Preferably the composition comprises one or more lipases, including “first cycle lipases” such as those described in U.S. Pat. No. 6,939,702 B1 and US PA 2009/0217464. Preferred lipases are first-wash lipases. The composition may comprise a first wash lipase.

Enzyme Stabilizing System. The composition may optionally comprise from about 0.001% to about 10% by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Builder. The composition may optionally comprise a builder or a builder system. Built cleaning compositions typically comprise at least about 1% builder, based on the total weight of the composition. Liquid cleaning compositions may comprise up to about 10% builder, and in some examples up to about 8% builder, of the total weight of the composition. Granular cleaning compositions may comprise up to about 30% builder, and in some examples up to about 5% builder, by weight of the composition.

Builders selected from aluminosilicates (e.g., zeolite builders, such as zeolite A, zeolite P, and zeolite MAP) and silicates assist in controlling mineral hardness in wash water, especially calcium and/or magnesium, or to assist in the removal of particulate soils from surfaces. Suitable builders may be selected from the group consisting of phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. These may be complemented by borates, e.g., for pH-buffering purposes, or by sulfates, especially sodium sulfate and any other fillers or carriers which may be important to the engineering of stable surfactant and/or builder-containing cleaning compositions. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Also suitable for use as builders herein are synthesized crystalline ion exchange materials or hydrates thereof having chain structure and a composition represented by the following general anhydride form: x(M₂O)·ySiO₂·zM′O wherein M is Na and/or K, M′ is Ca and/or Mg; y/x is 0.5 to 2.0; and z/x is 0.005 to 1.0.

Alternatively, the composition may be substantially free of builder. Chelating Agent. The composition may also comprise one or more metal ion chelating agents. Suitable molecules include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins, and mixtures therein. Chelating agents can be present in the acid or salt form including alkali metal, ammonium, and substituted ammonium salts thereof, and mixtures thereof.

Additional Amines: Additional amines may be used in the composition for added removal of grease and particulates from soiled materials. The compositions may comprise from about 0.1% to about 10%, in some examples, from about 0.1% to about 4%, and in other examples, from about 0.1% to about 2%, by weight of the cleaning composition, of additional amines. Non-limiting examples of additional amines may include, but are not limited to, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

Dye Transfer Inhibiting Agent. The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetri-acetic acid (HEDTA), tricthylenetetraaminchexaacetic acid (TTHA), N-hydroxyethyliminodiacetic acid (HEIDA), dihydroxyethylglycine (DHEG), ethylenediaminetetrapropionic acid (EDTP) and derivatives thereof or a combination thereof.

Bleaching Compounds, Bleaching Agents, Bleach Activators, and Bleach Catalysts. The compositions described herein may comprise bleaching agents, bleach activators and/or bleach catalysts. Bleaching ingredients may be present at levels of from about 1% to about 30%, and in some examples from about 5% to about 20%, based on the total weight of the composition. If present, the amount of bleach activator may be from about 0.1% to about 60%, and in some examples from about 0.5% to about 40%, of the composition. When the composition is a laundry composition in powder form, the composition preferably comprises percarbonate bleach, and a bleach activator, preferably TAED. If the composition is a laundry composition in liquid form, it is preferred that the liquid composition is substantially free of bleaching compounds.

Examples of bleaching agents include oxygen bleach, perborate bleach, percarboxylic acid bleach and salts thereof, peroxygen bleach, persulfate bleach, percarbonate bleach, and mixtures thereof.

In some examples, compositions may also include a transition metal bleach catalyst.

Bleaching agents other than oxygen bleaching agents are also known in the art and can be utilized in composition. They include, for example, photoactivated bleaching agents, or pre-formed organic peracids, such as peroxycarboxylic acid or salt thereof, or a peroxysulphonic acid or salt thereof.

Brightener. Optical brighteners or other brightening or whitening agents may be incorporated at levels of from about 0.01% to about 1.2%, by weight of the composition.

Commercial brighteners, which may be used herein, can be classified into subgroups, which include, but are not necessarily limited to, derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

In some examples, the fluorescent brightener is selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by Ciba Geigy Corporation), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by Ciba-Geigy Corporation), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal 5BM-GX by Ciba-Geigy Corporation). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, monoethanolamine, propane diol.

Fabric Hueing Agent. The composition may comprise a fabric hueing agent (sometimes referred to as shading, bluing or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Encapsulate. The composition may comprise an encapsulate. The encapsulate may comprises a core, a shell having an inner and outer surface, where the shell encapsulates the core.

Other ingredients. The composition can further comprise silicates. Suitable silicates can include, for example, sodium silicates, sodium disilicate, sodium metasilicate, crystalline phyllosilicates or a combination thereof. In some embodiments, silicates can be present at a level of from about 1% to about 20% by weight, based on the total weight of the composition.

The composition can further comprise other conventional detergent ingredients such as foam boosters, suds suppressors, anti-corrosion agents, soil-suspending agents, anti-soil redeposition agents, dyes, bactericides, tarnish inhibiters, and/or optical brighteners.

The composition can optionally further include saturated or unsaturated fatty acids, preferably saturated or unsaturated C₁₂-C₂₄ fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic cellulose, cationic starch, cationic polyacylamides or a combination thereof. If present, the fatty acids and/or the deposition aids can each be present at 0.1% to 10% by weight, based on the total weight of the composition.

The composition may optionally include silicone or fatty-acid based suds suppressors; hueing dyes, calcium and magnesium cations, visual signaling ingredients, anti-foam (0.001% to about 4.0% by weight, based on the total weight of the composition), and/or a structurant/thickener (0.01% to 5% by weight, based on the total weight of the composition) selected from the group consisting of diglycerides and triglycerides, ethylene glycol distearate, microcrystalline cellulose, microfiber cellulose, biopolymers, xanthan gum, gellan gum, and mixtures thereof).

### Additive Composition

The additive compositions of the present disclosure may include additional adjunct ingredients. Such adjuncts may provide additional treatment benefits to the target fabrics, and/or they may act as stabilization or processing aids to the compositions. Suitable adjuncts may include chelant, chlorine scavenger, malodor reduction materials, organic solvents, or mixtures thereof.

### Fabric Enhancer

The composition of the invention can be in the form of a fabric enhancer. The fabric enhancer for use herein comprises a fabric softening active. Suitable fabric softening actives, include, but are not limited to, materials selected from the group consisting of quats, amines, fatty esters, sucrose esters, silicones, dispersible polyolefins, clays, polysaccharides, fatty oils, polymer latexes and mixtures thereof. Preferably the fabric softening active is a quaternary ammonium compound, more preferably an ester quaternary ammonium compound, even more preferably a diester quaternary ammonium compound.

Typical minimum levels of incorporation of the fabric softening active in the fabric enhancer is at least about 1%, alternatively at least about 2%, alternatively at least about at least about 3%, alternatively at least about at least about 5%, alternatively at least about 10%, and alternatively at least about 12%, by weight of the fabric enhancer. The fabric enhancer may typically comprise maximum levels of fabric softening active of about less than about 90%, alternatively less than about 40%, alternatively less than about 30%, alternatively less than about 20%, by weight of the fabric enhancer.

### Method of Treating a Surface

The present disclosure relates to a method of treating a surface, the surface can be a hard surface or a soft surface, preferably the surface is a soft surface, more preferably the surface is a fabric.

For example, the method of the present disclosure may include contacting a fabric with a product according to the present disclosure. The contacting may occur in the presence of water, in its totality or partially. The product, or part thereof, may be diluted and/or dissolved in the water to form a treatment liquor.

The method of the present disclosure may include contacting a surface, preferably a fabric with an aqueous treatment liquor. The aqueous treatment liquor may comprise from about 1×10² Colony forming units (CFUs) to about 1×10⁸ CFU/liter of wash liquor, preferably from about 1×10⁴ CFUs to about 1×10⁷ CFU/liter of wash liquor of total bacterial spores, preferably Bacillus spores.

The method of treating a fabric may take place in any suitable vessel, in its entirety or partially, for example it may take place in an automatic washing machine. Such machines may be top-loading machines or front-loading machines. The whole process can take place in a washing machine. Alternatively, part of the process can take place in a washing machine and part of the process can take place in a dryer. The process of the invention is also suitable for hand washing applications.

The treatment step may be part of a wash or a rinse cycle of an automatic washing machine. The aqueous treatment liquor may be an aqueous rinse liquor. A product according to the present disclosure may be added to the drawer or drum of an automatic washing machine during a wash or a rinse cycle.

The treatment step of the method of the present disclosure may include contacting the fabric with an aqueous wash liquor. The step of contacting the fabric with an aqueous wash liquor may occur prior to contacting the fabric with an aqueous rinse liquor. Such steps may occur during a single treatment cycle. The aqueous wash liquor may comprise a cleaning composition, such as a granular or liquid laundry detergent composition, that is dissolved or diluted in water. The detergent composition may include anionic surfactant. The aqueous wash liquor may comprise from about 50 to about 5000 ppm, or from about 100 to about 1000 ppm, anionic surfactant.

The bacterial spores, preferably Bacillus spores may be added from an additive composition in a level of from about 0.01% to about 5% by weight of the fabric. Preferably, the bacterial spores are provided as part of beads or a part of a dryer sheet.

The fabric treated may be a natural or a synthetic fabric. Suitable synthetic fabrics include polyester, acrylic, nylon, rayon, acetate, spandex, latex, and/or orlon fabrics. The composition and method of the invention provides very good malodor removal and/or prevention on synthetic fabric.

The fabric treated may include synthetic fibers. Suitable synthetic fibers may include polyester, acrylic, nylon, rayon, acetate, spandex, latex, and/or orlon fibers. The fibers may be elastic and/or contain elastane. The fabric may contain blends of synthetic fibers and natural fibers (e.g., a polycotton blend). The fabric may comprise fibers that are relatively hydrophobic (for example, compared to cotton fibers).

### Examples

The following test evaluates the impact of cationic poly alpha-1,6-glucan and cationic hydroxyethylcellulose on Bacillus spore deposition from laundry detergent wash solutions.

### Washing Protocol and Spore Deposition Analysis Method:

Knitted cotton swatches (GMT desized knitted cotton, Warwick Equest Ltd, Consett, UK) were washed with a liquid laundry detergent in an experiment involving four external and two internal replicates for each treatment.
The liquid laundry detergent was prepared with the following composition:

| | % active |
|---|---|
| | in Formula |
| Water | 70.7 |
| Non-ionic | 12.7 |
| C12-18 Fatty Acid | 1.7 |
| Linear alkylbenzene sulfonate | 6.7 |
| DTPA | 0.3 |
| Ethoxylated Polyethyleneimine | 2 |
| Enzymes (Protease, | 0.17 |
| Xyloglucanase) | |
| Brightener | 0.04 |
| Antibacterial actives | 0.15 |
| Antifoam | 0.03 |
| Misc. (e.g. pH adjusters, salt, | Balance |
| solvent, preservative) | |

| Test leg | Wash addition |
|---|---|
| A | 1 g/L Detergent 1 + Bacillus spores |
| B | 1 g/L Detergent 1+ Bacillus spores |
| | pre-complexed with 80 mg/L cationic |
| | poly alpha-1,6-glucan (cat-glucan) |
| C | 1 g/L Detergent 1 + Bacillus spores |
| | pre-complexed with 80 mg/L cationic |
| | hydroxyethylcellulose (cat-HEC) |

The wash and rinse cycles were completed in a 1 L tergotometer containing city water (Northumbrian Water, 9 grains per gallon (US)), with 60 g of 5 cm×5 cm knitted cotton swatches. Bacillus spore premix (Genesis Biosciences, Cardiff, UK) was dosed to give a total count of 5×106 colony forming units (CFU)/L in the wash. In the case of legs B and C, the spores were premixed with 80 mg of cationic hydroxyethylcellulose (SupraCare™ 150, DOW Chemical) or 80 mg of cationic poly alpha-1,6-glucan ether compound polymer (International Flavors & Fragrances Inc.) immediately before addition to the wash. The fabrics were washed for 17 minutes at 26° C., 208 rpm, and then rinsed twice for 5 minutes in fresh city water (15° C.). A stock 1 L wash solution was also made up adding the desired number of spores, and samples of this stock solution were taken for Initial CFU/g fabric readings.
Knitted cotton swatches were removed after the rinse cycle and were analysed for spore deposition via vortex extraction with 0.45 ml of 0.1% Tween 80 (P8074 Sigma-Aldrich) in 9 ml of 0.85% physiological saline (Trafalgar Scientific, Leicester, UK) to give a 10⁰ dilution. 10⁻¹ dilution was achieved through 1 ml serial dilution into 9 ml physiological saline. 200 μl aliquots of the 10⁰ and 10⁻¹ dilutions were plated in duplicate onto Tryptic Soy Agar (TSA) plates (Biomerieux UK Ltd, Basingstoke, UK) and spread with a sterile plastic wedge shaped spreader (Trafalgar Scientific, Leicester, UK). Plates were incubated at 35° C. for 18-24 hours and the resulting colonies were counted by eye. Counts from plates containing between 20 and 200 colonies were used to calculate the total colony forming units (CFU) per gram of fabric—see calculations below. Similarly, the initial count samples were plated directly onto TSA plates for a 10⁰ dilution or were serially diluted with 1 ml into 9 ml of 0.85% physiological saline for a 10⁻¹ dilution then plated onto TSA plates. Counts from these plates were used to calculate the total CFU available per gram of fabric in the wash solution at the start as a theoretical 100% deposition to allow for a % deposition onto fabric calculation.

### Calculations:

### Fabric Extraction:

$$CFU / g fabric = CFU \times ( 1000 / 200 ) \times 9.45 ( to give total CFU in 9.45 ml extraction solution ) \times 1 / 0.826 g ( swatch to gram conversion ) \times Dilution factor$$

### Initial:

$$Initial CFU / g fabric = ( CFU \times ( 1000 / 200 \times 1000 ) ) / 60 g \times Dilution factor$$

### Percentage Deposition:

$$\% deposition = ( ( Inital CFU / g ) / ( Fabric CFU / g ) ) \times 100$$

### Results:

| | Mean | Standard | Mean % spore | Standard |
|---|---|---|---|---|
| Treatment | log(CFU/g) | deviation | deposition | deviation |
| A - Nil polymer | 2.84 | 0.137 | 1.19 | 0.345 |
| B - Cat-glucan | 3.36 | 0.0448 | 3.86 | 0.408 |
| C - Cat-HEC | 3.00 | 0.101 | 1.72 | 0.430 |

### ANOVA

A one-way ANOVA was performed to compare the effect of two polymers on Bacillus spore % deposition onto knitted cotton through the wash.
A one-way ANOVA revealed that there was a statistically significant difference in Bacillus spore deposition between at least two groups (F(2, 8)=[45.561], p=4.243e−05).

### Tukey's HSD:

| Treatment | Lower | Upper | |
|---|---|---|---|
| comparison | bound | bound | P value |
| A-B | −3.54 | −1.79 | 0.0000625 |
| A-C | −1.41 | 0.35 | 0.255 |
| B-C | −2.95 | −1.33 | 0.0001758 |

Tukey's HSD revealed that cat-glucan achieved significantly greater deposition compared with cat-HEC and nil polymer respectively.

### CONCLUSION

Cationic poly alpha-1,6-glucan causes a 3.2-fold increase in Bacillus spore deposition from wash solutions, a result that is statistically significant to >99.9% confidence level. Cationic hydroxyethylcellulose did not have a statistically significant impact on Bacillus spore deposition.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A surface treatment composition, for application in laundry, dish and hard surface cleaning, comprising:
a) from about 1×10² to about 1×10⁹ CFU/g of the composition of Bacillus spores;
b) from about 0.01% to about 5% by weight of the composition of a cationic polyglucan.

2. A composition according to claim 1 wherein the Bacillus is selected from the group consisting of Bacillus subtilis, Bacillus amyloliquefaciens, Bacillus licheniformis, Bacillus megaterium, Bacillus pumilus, Bacillus cereus, Bacillus thuringiensis, Bacillus mycoides, Bacillus tequilensis, Bacillus vallismortis, Bacillus mojavensis and mixtures thereof.

3. A composition according to claim 1 wherein the Bacillus is selected from the group consisting of Bacillus subtilis, Bacillus amyloliquefaciens, Bacillus licheniformis, Bacillus megaterium, Bacillus pumilus and mixtures thereof.

4. A composition according to claim 1 wherein the cationic polyglucan is selected from group consisting of a poly alpha-1,3-glucan ether compound, a poly alpha-1,6-glucan ether compound, and a mixture thereof.

5. A composition according to claim 1 wherein the cationic polyglucan comprises a poly alpha-1,3-glucan ether compound characterized by:
(a) a weight average molecular weight of from about 90 kDaltons to about 350 kDaltons, and
(b) a degree of cationic substitution of from about 0.15 to about 0.8.

6. A composition according to claim 1 wherein the cationic polyglucan comprises a poly alpha-1,6-glucan ether compound comprising a backbone of glucose monomer units wherein at least about 65% of the glucose monomer units are linked via alpha-1,6-glycosidic linkages, and
wherein the poly alpha-1,6-glucan ether compound is characterized by:
i) a weight average degree of polymerization of from about 500 to about 2000, and
ii) a degree of substitution of about 0.001 to about 3.0.

7. A composition according to claim 1 wherein the composition is a cleaning composition comprising a surfactant system.

8. The composition according to claim 1 wherein the composition is a hard surface cleaning composition, an aqueous cleaning composition in concentrate form or in the form of ready-to-use composition.

9. The composition according to claim 1 wherein the composition is a laundry cleaning composition comprising an enzyme selected from the group consisting of an amylase, protease, lipase, cellulase and a mixture thereof.

10. A composition according to claim 1 wherein the composition is a laundry composition comprising a cellulase.

11. A composition according to claim 1 wherein the composition comprises an adjunct comprising one or more of: peroxy compounds, bleach activators, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, bleach agents, colorants, scents, processing aids and mixtures thereof.

12. A composition according to claim 1 wherein the composition is a laundry additive in the form of a bead or dryer sheet.

13. A composition according to claim 1 wherein the composition is a fabric enhancer comprising a conditioning agent.

14. A method of treating a surface, the method comprising the step of treating the surface with a composition according to claim 1.
